(19) United States
(12) Patent Application Publication
(10) Pub. No.: US 2026/0020071 A1
(43) Pub. Date: Jan. 15, 2026

(54) PRACH CONFIGURATIONS FOR GREEN NETWORKS

(71) Applicant: QUALCOMM Incorporated, San Diego, CA (US)

(72) Inventors: Ahmed Attia ABOTABL, San Diego, CA (US); Navid ABEDINI, Basking Ridge, NJ (US); Jae Ho RYU, San Diego, CA (US); Hung Dinh LY, San Diego, CA (US)

(21) Appl. No.: 18/770,402

(22) Filed: Jul. 11, 2024

(51) Int. Cl. H04W 74/0833

(52) U.S. Cl. CPC H04W 74/0833

(57) ABSTRACT

Apparatus, methods, and computer program products for wireless communication are provided. An example method may include receiving, from a first network entity, a first physical random access channel (PRACH) configuration. The example method may further include receiving, from the first network entity, a second PRACH configuration. The example method may further include communicating with the first network entity based on at least one of the first PRACH configuration and the second PRACH configuration.

### TECHNICAL FIELD

The present disclosure relates generally to communication systems, and more particularly, to wireless communication systems with a physical random access channel (PRACH).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a first network entity, a first physical random access channel (PRACH) configuration. Based at least in part on information stored in the at least one memory, the at least one processor, individually or in any combination, is configured to receive, from the first network entity, a second PRACH configuration. Based at least in part on information stored in the at least one memory, the at least one processor, individually or in any combination, is configured to communicate with the first network entity based on at least one of the first PRACH configuration and the second PRACH configuration.

In another aspect of the disclosure, a method, a computer-readable medium, and an apparatus at a network entity are provided. The apparatus may include at least one memory and at least one processor coupled to the at least one memory. Based at least in part on information stored in the at least one memory, the at least one processor, individually or in any combination, is configured to transmit, for a user equipment (UE), a first physical random access channel (PRACH) configuration. Based at least in part on information stored in the at least one memory, the at least one processor, individually or in any combination, is configured to transmit, for the UE, a second PRACH configuration. Based at least in part on information stored in the at least one memory, the at least one processor, individually or in any combination, is configured to communicate with the UE based on at least one of the first PRACH configuration and the second PRACH configuration.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a four-step random access procedure (4-step random access channel (RACH)).

FIG. 5 is a diagram illustrating a two-step random access procedure (2-step RACH).

FIG. 6 is a diagram illustrating example communications between a network entity and a UE.

FIG. 7 is a diagram illustrating an example of RACH adaptation with a first RACH configuration and a second RACH configuration.

FIG. 8 is a diagram illustrating an example of synchronization signal block (SSB) mapping with a first RACH configuration and a second RACH configuration.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Physical random access channel (PRACH) adaptation can save network energy by optimizing the number of RACH occasions (ROs) based on the number of ROs that the user equipment (UE may be expected to use (e.g., based on a need of the UE). Under a first approach, a network may configure a UE with a sparse configuration as an initial RACH configuration and dynamically add more ROs based on the number of ROs that the UE may be expected to use (e.g., based on a need of the UE). Under a second approach, the network may configure the UE with a dense configuration as an initial RACH configuration and dynamically remove ROs based on the number of ROs that the UE may be expected to use (e.g., based on a need of the UE). Under the second approach, potential cross-link interference may be caused by UEs that do not have the capability of dynamically changing number of ROs in the RACH occasions that are muted (e.g., removed). For the first approach, adding ROs may occur in multiple ways. For example, a way of adding ROs may include updating the PRACH configuration index or subset of parameters determined by the PRACH configuration index. However, updating the PRACH configuration index or the periodicity may result in a configuration that doesn't include the RACH configuration not associated with dynamic updates (e.g., legacy RACH configuration) as a subset. Such a configuration that doesn't include the RACH configuration not associated with dynamic updates (e.g., legacy RACH configuration) as a subset may be inefficient. Aspects provided herein include mechanisms for PRACH adaptation based on more than one PRACH configuration so that update the RACH configuration while maintaining a nested structure where merging two PRACH configurations would be possible.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

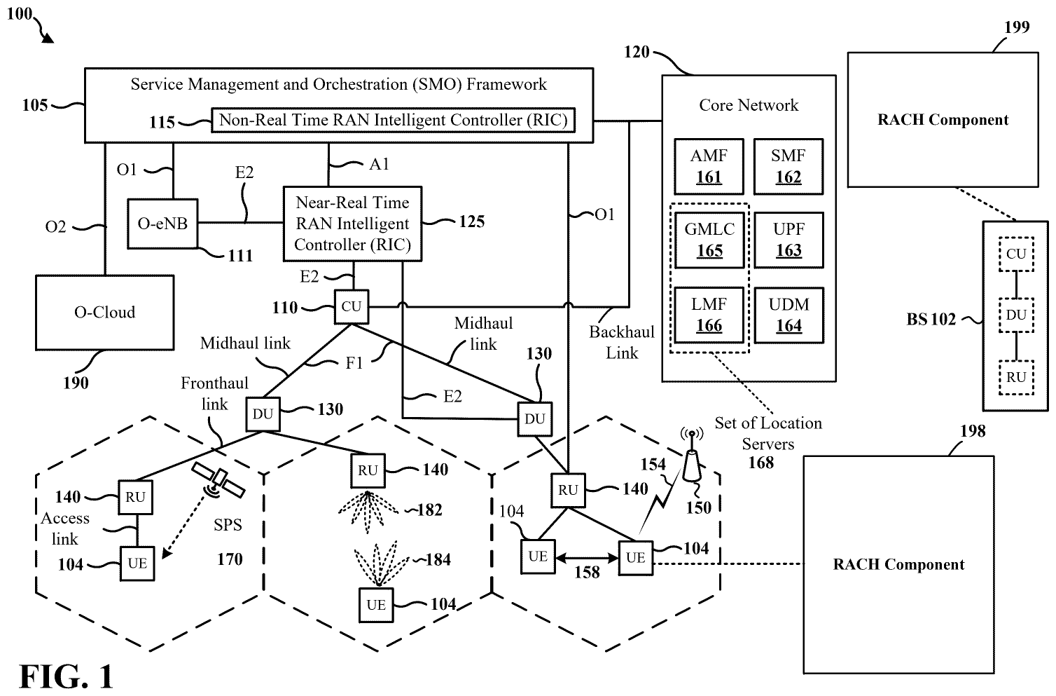

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHz-7.125 GHz) and FR2 (24.25 GHz-52.6 GHz). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a RACH component 198. In some aspects, the RACH component 198 may be configured to receive, from a first network entity, a first physical random access channel (PRACH) configuration. In some aspects, the RACH component 198 may be further configured to receive, from the first network entity, a second PRACH configuration. In some aspects, the RACH component 198 may be further configured to communicate with the first network entity based on at least one of the first PRACH configuration and the second PRACH configuration.

In certain aspects, the base station 102 may include a RACH component 199. In some aspects, the RACH component 199 may be configured to transmit, for a UE, a first PRACH configuration. In some aspects, the RACH component 199 may be further configured to transmit, for the UE, a second PRACH configuration. In some aspects, the RACH component 199 may be further configured to communicate with the UE based on at least one of the first PRACH configuration and the second PRACH configuration.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

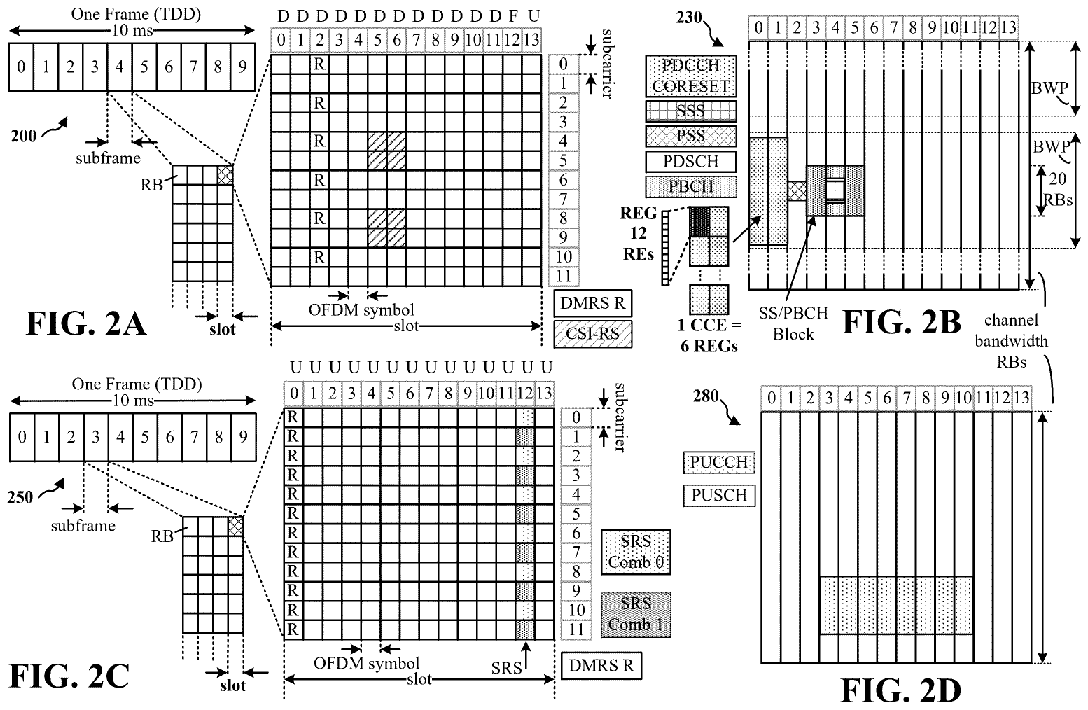

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}+15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

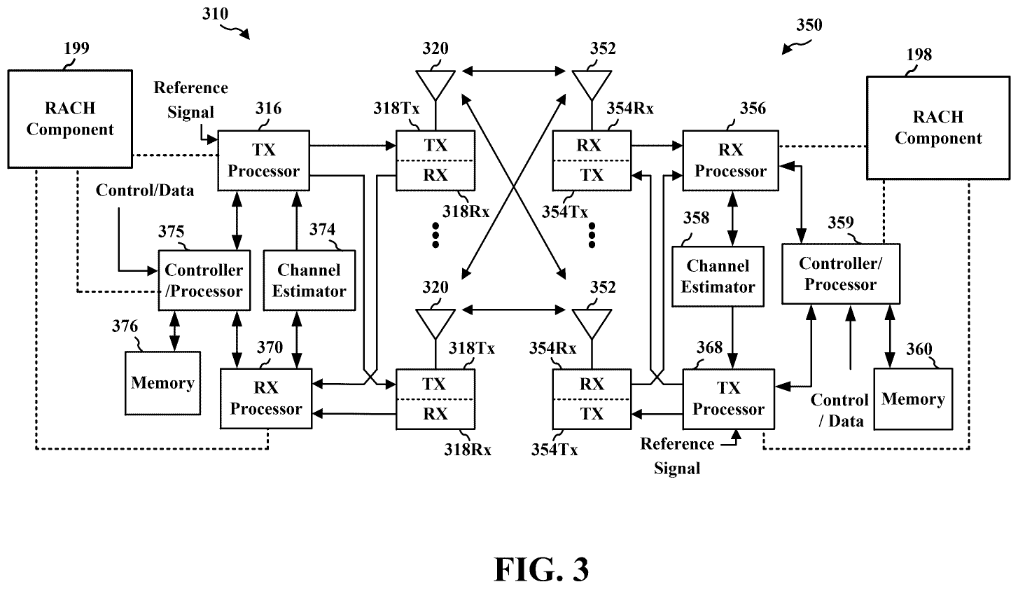

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with RACH component 198 of FIG. 1.

At least one of the TX processor 316, the RX processor 370, and the controller/processor 375 may be configured to perform aspects in connection with RACH component 199 of FIG. 1.

To reduce power consumption, adaptation (which may also be referred to as “dynamic adaptation) may be employed in wireless communication systems. As an example, adaptation of synchronization signal block (SSB) in the time domain (e.g., adapting periodicity) may be performed. Under dynamic adaptation of SSB, the network may indicate a dynamic adaptation of the actually transmitted SSBs. Adaptation of SSB may include dynamically varying the periodicity or transmission pattern of SSB. Dynamic adaptation of SSB transmission or on-demand SSBs/SIBI transmissions or SSB-less operations may also enable long periods of inactivity at the network node and potentially provide energy savings. Example adaptations may include leveraging SSB-less cell operations and potential enhancements for SSB-less cells, e.g., support SSB-less cell operation for inter-band carrier aggregation (CA), or support offloading system information from one cell to another for inter-band CA. Example adaptations may also include support of signals/channels to aid discovery of cells in lieu of SSBs. Example adaptations may also include mechanism for UE to trigger on-demand SSB transmission for fast access/fast cell activation. Example adaptations may also include adaptation of SSB periodicity at beam level (e.g., adapting SSB in a particular fashion associated with a particular beam, which may also be referred to as spatial filter, while adapting SSB differently (or not adapting the SSB) for a different beam).

As another example, in addition adaptation of SSB, adaptation of PRACH configurations in the time-domain may also be performed. PRACH adaptation can save network energy by optimizing the number of RACH occasions (ROs) based on the number of ROs that the UE may be expected to use (e.g., based on a need of the UE). As used herein, the term “RACH configuration” and “PRACH configuration” may be used interchangeably. Under a first approach, a network may configure a UE with a sparse configuration as an initial RACH configuration and dynamically add more ROs based on the number of ROs that the UE may be expected to use (e.g., based on a need of the UE). Under a second approach, the network may configure the UE with a dense configuration as an initial RACH configuration and dynamically remove ROs based on the number of ROs that the UE may be expected to use (e.g., based on a need of the UE). Under the second approach, potential cross-link interference may be caused by UEs that do not have the capability of dynamically changing number of ROs in the RACH occasions that are muted (e.g., removed). For the first approach, adding ROs may occur in multiple ways. For example, a way of adding ROs may include updating the PRACH configuration index or subset of parameters determined by the PRACH configuration index. However, updating the PRACH configuration index or the periodicity may result in a configuration that doesn't include the RACH configuration not associated with dynamic updates (e.g., legacy RACH configuration) as a subset. Such a configuration that doesn't include the RACH configuration not associated with dynamic updates (e.g., legacy RACH configuration) as a subset may be inefficient. Aspects provided herein include mechanisms for PRACH adaptation based on more than one PRACH configuration so that update the RACH configuration while maintaining a nested structure where merging two PRACH configurations would be possible.

A UE may use a random access procedure in order to communicate with a base station. For example, the UE may use the random access procedure to request an RRC connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., The UE may use contention based random access (CBRA) may be performed when a UE is not synchronized with a base station, and the CFRA may be applied, e.g., when the UE was previously synchronized to a network node. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

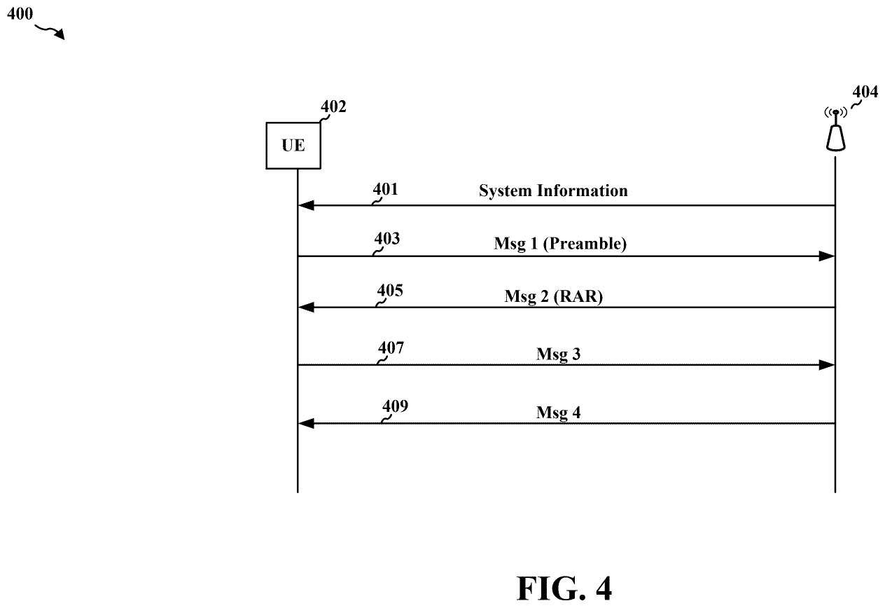

FIG. 4 illustrates example aspects of a four-step random access procedure 400 between a UE 402 and a network node 404. The UE 402 may initiate the random access message exchange by sending, to the network node 404, a first random access message 403 (e.g., message (Msg) 1) including a preamble. Prior to sending the first random access message 403, the UE may obtain random access parameters, e.g., including preamble format parameters, time and frequency resources, parameters for determining root sequences and/or cyclic shifts for a random access preamble, etc., e.g., in system information 401 from the network node 404. The preamble may be transmitted with an identifier, such as a Random Access RNTI (RA-RNTI). The UE 402 may randomly select a random access preamble sequence, e.g., from a set of preamble sequences. If the UE 402 randomly selects the preamble sequence, the network node 404 may receive another preamble from a different UE at the same time. In some examples, a preamble sequence may be assigned to the UE 402.

The network node responds to the first random access message 403 by sending a second random access message 405 (e.g., Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the random access message 405, the UE 402 may transmit a third random access message 407 (e.g., Msg 3) to the network node 404, e.g., using PUSCH, that may include a RRC connection request, an RRC connection re-establishment request, or an RRC connection resume request, depending on the trigger for the initiating the random access procedure. The network node 404 may then complete the random access procedure by sending a fourth random access message 409 (e.g., Msg 4) to the UE 402, e.g., using PDCCH for scheduling and PDSCH for the message. The fourth random access message 409 may include a random access response message that includes timing advancement information, contention resolution information, and/or RRC connection setup information. The UE 402 may monitor for PDCCH, e.g., with the C-RNTI. If the PDCCH is successfully decoded, the UE 402 may also decode PDSCH. The UE 402 may send HARQ feedback for any data carried in the fourth random access message. If two UEs sent a same preamble at 403, both UEs may receive the RAR leading both UEs to send a third random access message 407. The network node 404 may resolve such a collision by being able to decode the third random access message from one of the UEs and responding with a fourth random access message to that UE. The other UE, which did not receive the fourth random access message 409, may determine that random access did not succeed and may re-attempt random access. Thus, the fourth message may be referred to as a contention resolution message. The fourth random access message 409 may complete the random access procedure. Thus, the UE 402 may then transmit uplink communication and/or receive downlink communication with the network node 404 based on the random access message 409.

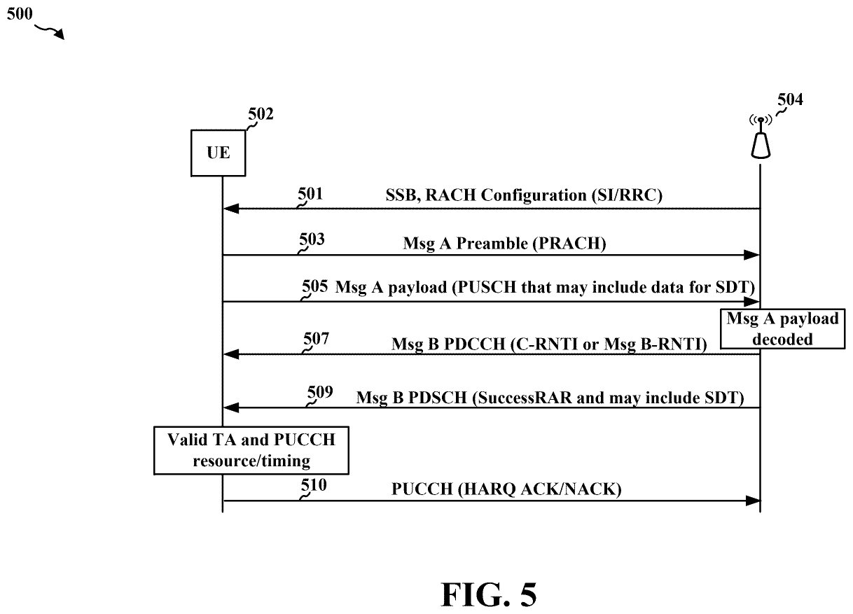

In order to reduce latency or control signaling overhead, a single round trip cycle between the UE and the network node may be achieved in a 2-step RACH process, such as shown in example 500 of FIG. 5. Aspects of Msg 1 and Msg 3 may be combined in a single message, e.g., which may be referred to as Msg A. Prior to sending the first random access message 503 (which may be a preamble), the UE 502 may obtain random access parameters, e.g., including preamble format parameters, time and frequency resources, parameters for determining root sequences and/or cyclic shifts for a random access preamble, etc., e.g., in the SSB or RACH configuration (e.g., system information or RRC signaling) at 501 from the network node 504. The UE 502 transmits a Msg A may include a random access message 503, and may also include a PUSCH transmission 505, e.g., such as data for a small data transfer (SDT). The MsgA preambles may be separate from the four step preambles, yet may be transmitted in the same random access occasions (ROs) as the preambles of the four step RACH procedure or may be transmitted in separate ROs. The PUSCH transmissions may be transmitted in PUSCH occasions (POs) that may span multiple symbols and PRBs. After the UE 502 transmits the Msg A (e.g., 503 and/or 505), the UE 502 may wait for a response from the network node 504. Aspects of the Msg 2 and Msg 4 in the four-step RACH of FIG. 4 may be combined into a single message, which may be referred to as Msg B. The two-step RACH may be triggered for reasons similar to a four-step RACH procedure. If the UE 502 does not receive a response, the UE 502 may retransmit the MsgA or may fall back to a four-step RACH procedure starting with a Msg 1. If the network node 504 detects the Msg A, but fails to successfully decode the Msg A PUSCH, the network node 504 may respond with an allocation of resources for an uplink retransmission of the PUSCH. The UE 502 may fall back to the four step RACH with a transmission of Msg 3 based on the response from the network node and may retransmit the PUSCH from Msg A. If the network node 504 successfully decodes the Msg A and corresponding PUSCH, the network node 504 may reply with an indication of the successful receipt, e.g., as a random access response that completes the two-step RACH procedure. FIG. 5 shows that the Msg B may include a Msg B PDCCH 507 and a Msg B PDSCH 509 indicating the successful receipt, e.g., RAR). The Msg B may include the random access response and a contention-resolution message. The contention resolution message may be sent after the network node successfully decodes the PUSCH transmission. In some aspects, the Msg B PDSCH 509 may include data, e.g., as part of an SDT. The UE may then have a valid timing advance (TA) and PUCCH resource timing. The UE 502 may transmit a PUCCH 510 with ACK/NACK feedback for the Msg B received from the network node 504.

PRACH may be based on a PRACH configuration, which may be specified based on an information element (IE) RACH-ConfigCommon which may be provided from the network to a UE. A RACH configuration may include a variety of different parameters. An example configuration of a RACH configuration is provided below:

| | |
|---|---|
| RACH-ConfigCommon ::= | SEQUENCE { |
| rach-ConfigGeneric | RACH-ConfigGeneric, |
| totalNumberOfRA-Preambles | INTEGER (1..63) |

OPTIONAL, -- Need S
ssb-perRACH-OccasionAndCB-PreamblesPerSSB CHOICE {

| | |
|---|---|
| oneEighth | ENUMERATED |

{n4,n8,n12,n16,n20,n24,n28,n32,n36,n40,n44,n48,n52,n56,n60,n64},

| | |
|---|---|
| oneFourth | ENUMERATED |

{n4,n8,n12,n16,n20,n24,n28,n32,n36,n40,n44,n48,n52,n56,n60,n64},

| | |
|---|---|
| oneHalf | ENUMERATED |

{n4,n8,n12,n16,n20,n24,n28,n32,n36,n40,n44,n48,n52,n56,n60,n64},

| | |
|---|---|
| one | ENUMERATED |

{n4,n8,n12,n16,n20,n24,n28,n32,n36,n40,n44,n48,n52,n56,n60,n64},

| | |
|---|---|
| two | ENUMERATED {n4,n8,n12,n16,n20,n24,n28,n32}, |
| four | INTEGER (1..16), |
| eight | INTEGER (1..8), |
| sixteen | INTEGER (1..4) |
| } | OPTIONAL, -- |

Need M

| | |
|---|---|
| groupBconfigured | SEQUENCE { |
| ra-Msg3SizeGroupA | ENUMERATED {b56, b144, b208, b256, b282, |

b480, b640,

b800, b1000, b72, spare6, spare5,spare4, spare3,

```
spare2, spare1},
    messagePowerOffsetGroupB ENUMERATED { minusinfinity, dB0, dB5,
dB8, dB10, dB12, dB15, dB18},
    numberOfRA-PreamblesGroupA INTEGER (1..64)
```

| | |
|---|---|
| } | OPTIONAL, -- |

Need R
ra-ContentionResolutionTimer ENUMERATED { sf8, sf16, sf24, sf32, sf40,
sf48, sf56, sf64},

| | |
|---|---|
| rsrp-ThresholdSSB | RSRP-Range |

OPTIONAL, -- Need R

| | |
|---|---|
| rsrp-ThresholdSSB-SUL | RSRP-Range |

OPTIONAL, -- Cond SUL

| | |
|---|---|
| prach-RootSequenceIndex | CHOICE { |
| 1839 | INTEGER (0..837), |
| 1139 | INTEGER (0..137) |

},

| | |
|---|---|
| msg1-SubcarrierSpacing | SubcarrierSpacing |

OPTIONAL, -- Cond L139

| | |
|---|---|
| restrictedSetConfig | ENUMERATED {unrestrictedSet, |

restrictedSetTypeA, restrictedSetTypeB},

| | |
|---|---|
| msg3-transformPrecoder | ENUMERATED {enabled} |

```
OPTIONAL, -- Need R
  ...,
  [[
  ra-PrioritizationForAccessIdentity-r16 SEQUENCE {
```

| | |
|---|---|
| ra-Prioritization-r16 | RA-Prioritization, |
| ra-PrioritizationForAI-r16 | BIT STRING (SIZE (2)) |
| } | OPTIONAL, -- |

Cond InitialBWP-Only

| | |
|---|---|
| prach-RootSequenceIndex-r16 | CHOICE { |
| 1571 | INTEGER (0..569), |
| 11151 | INTEGER (0..1149) |

```
  } OPTIONAL -- Need R
  ]],
  [[
  ra-PrioritizationForSlicing-r17 RA-PrioritizationForSlicing-r17
OPTIONAL, -- Cond InitialBWP-Only
  featureCombinationPreamblesList-r17 SEQUENCE
(SIZE(1..maxFeatureCombPreamblesPerRACHResource-r17)) OF
FeatureCombinationPreambles-r17 OPTIONAL -- Cond AdditionalRACH
  ]]
}
```

A RACH configuration may include a series of preamble partitions each associated to a combination of features and 4-step random access (RA), which may be represented by the IE featureCombinationPreamblesList. The RACH configuration may further include a threshold for preamble selection (which may be a value in dB), which may be represented by IE messagePowerOffsetGroupB. The RACH configuration may further include subcarrier spacing of PRACH, which may be represented by IE msg1-SubcarrierSpacing.

The RACH configuration may further include an indication to enable the transform precoder for msg3 transmission, which may be represented by IE msg3-transformPrecoder. The RACH configuration may further include a number of contention-based (CB) preambles per SSB in group A (which may determine implicitly the number of CB preambles per SSB available in group B), which may be represented by IE numberOfRA-PreamblesGroupA.

The RACH configuration may further include a PRACH root sequence index, which may be represented by IE prach-RootSequenceIndex. The RACH configuration may further include an initial value for the contention resolution timer, which may be represented by IE ra-ContentionResolutionTimer.

The RACH configuration may further include a transport Blocks size threshold in bits below which the UE may use a contention-based RA preamble of group A, which may be represented by IE ra-Msg3SizeGroupA. The RACH configuration may further include parameters which apply for prioritized random access procedure on UL BWP of special cell (SpCell) for specific Access Identities, which may be represented by IE ra-Prioritization. The RACH configuration may further include an indication of whether the field ra-Prioritization-r16 applies for Access Identities, which may be represented by IE ra-PrioritizationForAI.

The RACH configuration may further include parameters which apply to configure prioritized CBRA 4-step random access type for slicing, which may be represented by IE ra-PrioritizationForSlicing. The RACH configuration may further include RACH parameters for both regular random access and beam failure recovery, which may be represented by IE rach-ConfigGeneric. The RACH configuration may further include configuration of an unrestricted set or one of two types of restricted sets, which may be represented by IE restrictedSetConfig. The RACH configuration may further include a threshold that the UE may select the SS block and corresponding PRACH resource for path-loss estimation and (re)transmission based on SS blocks that satisfy the threshold, which may be represented by IE rsrp-ThresholdSSB. The RACH configuration may further include a threshold that the UE selects a supplementary uplink (SUL) carrier to perform random access based on, which may be represented by IE rsrp-ThresholdSSB-SUL.

The RACH configuration may further include information about the number of SSBs per RACH occasion and information of total number of CB preambles in a RACH occasion, which may be represented by IE ssb-perRACH-OccasionAndCB-PreamblesPerSSB. The RACH configuration may further include information about total number of preambles used for contention based and contention free 4-step or 2-step random access in the PRACH resources, which may be represented by IE totalNumberOfRA-Preambles.

Within the RACH parameters for both regular random access and beam failure recovery, which may be represented by IE rach-ConfigGeneric, there may be various parameters provided. An example rach-ConfigGeneric is provided below:

| | |
|---|---|
| RACH-ConfigGeneric ::= | SEQUENCE { |
| prach-ConfigurationIndex | INTEGER (0..255), |
| msg1-FDM | ENUMERATED {one, two, four, eight}, |
| msg1-FrequencyStart | INTEGER (0..maxNrofPhysicalResourceBlocks−1), |
| zeroCorrelationZoneConfig | INTEGER(0..15), |

preambleReceivedTargetPower INTEGER (−202..−60),

| | |
|---|---|
| preambleTransMax | ENUMERATED {n3, n4, n5, n6, n7, n8, n10, n20, |

n50, n100, n200},

| | |
|---|---|
| powerRampingStep | ENUMERATED {dB0, dB2, dB4, dB6}, |
| ra-ResponseWindow | ENUMERATED {sl1, sl2, sl4, sl8, sl10, sl20, sl40, |

```
sl80},
  ...,
  [[
  prach-ConfigurationPeriodScaling-IAB-r16 ENUMERATED
{scf1,scf2,scf4,scf8,scf16,scf32,scf64} OPTIONAL, -- Need R
  prach-ConfigurationFrameOffset-IAB-r16 INTEGER (0..63)
OPTIONAL, -- Need R
  prach-ConfigurationSOffset-IAB-r16 INTEGER (0..39)
OPTIONAL, -- Need R
  ra-ResponseWindow-v1610 ENUMERATED { sl60, sl160}
OPTIONAL, -- Need R
  prach-ConfigurationIndex-v1610 INTEGER (256..262)
OPTIONAL -- Need R
  ]],
  [[
  ra-ResponseWindow-v1700 ENUMERATED {sl240, sl320, sl640,
sl960, sl1280, sl1920, sl2560} OPTIONAL -- Need R
  ]]
}
```

The RACH parameters for both regular random access and beam failure recovery, which may be represented by IE rach-ConfigGeneric, may include an of lowest PRACH transmission occasion in frequency domain with respective to PRB 0 (configured so that the corresponding PRACH resource is entirely within the bandwidth of the UL BWP), represented by IE msg1-FrequencyStart. The RACH parameters for both regular random access and beam failure recovery, which may be represented by IE rach-ConfigGeneric, may include power ramping steps for PRACH, represented by IE powerRampingStep. The RACH parameters for both regular random access and beam failure recovery, which may be represented by IE rach-ConfigGeneric, may include frame offset for ROs defined in the baseline configuration indicated by prach-ConfigurationIndex, represented by IE prach-ConfigurationFrameOffset-IAB. The RACH parameters for both regular random access and beam failure recovery, which may be represented by IE rach-ConfigGeneric, may include PRACH configuration index (which defines the ROs), represented by IE prach-ConfigurationIndex.

The RACH parameters for both regular random access and beam failure recovery, which may be represented by IE rach-ConfigGeneric, may include scaling factor to extend the periodicity of the baseline configuration, represented by IE prach-ConfigurationPeriodScaling-IAB. The RACH parameters for both regular random access and beam failure recovery, which may be represented by IE rach-ConfigGeneric, may include subframe/slot offset for ROs, represented by IE prach-ConfigurationSOffset-IAB. The RACH parameters for both regular random access and beam failure recovery, which may be represented by IE rach-ConfigGeneric, may include target power level at the network receiver side, represented by IE preambleReceivedTargetPower.

The RACH parameters for both regular random access and beam failure recovery, which may be represented by IE rach-ConfigGeneric, may include a maximum number of RA preamble transmission performed before declaring a failure, represented by IE preambleTransMax. The RACH parameters for both regular random access and beam failure recovery, which may be represented by IE rach-ConfigGeneric, may include Msg2 (RAR) window length in number of slots, represented by IE ra-ResponseWindow. The RACH parameters for both regular random access and beam failure recovery, which may be represented by IE rach-ConfigGeneric, may include N-CS (cyclic shifts of a plurality of the shift increments) configuration, represented by IE zeroCorrelationZoneConfig. Aspects presented herein may enable UEs to adaptively use a PRACH for the benefit of power saving. For instance, there may be multiple PRACH configurations and procedures based on these aspects. Aspects presented herein may also allow for an option to enable PRACH adaptation.

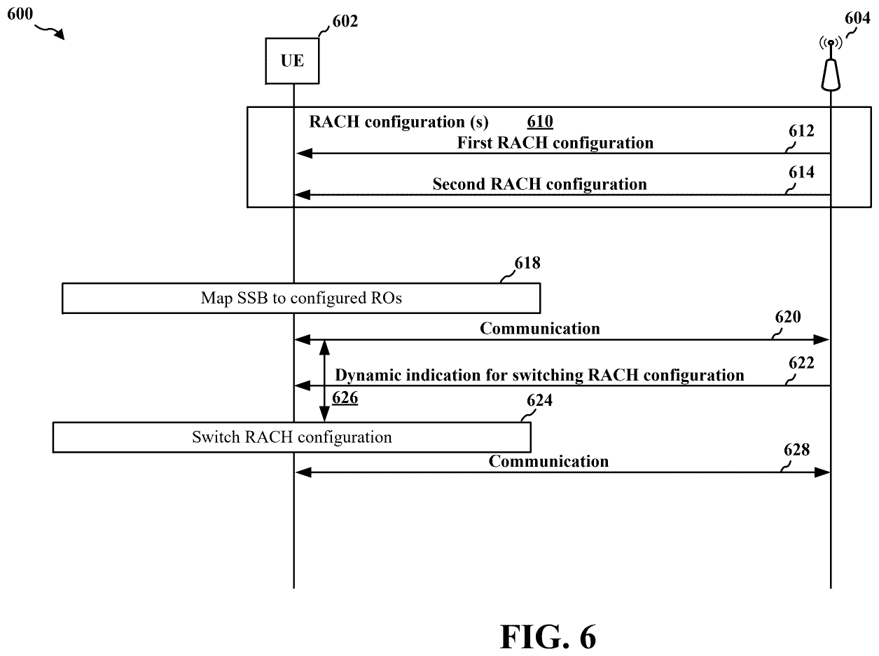

FIG. 6 is a diagram 600 illustrating example communications between a network entity 604 and a UE 602.

In some aspects, a network may indicate two separate RACH configurations such that each RACH configuration may be used by a different type of UE. As illustrated in FIG. 6, to configure RACH configuration(s) 610 for the UE 602, the network entity 604 may transmit a first RACH configuration 612 and a second configuration 614 to the UE 602. For example, the first RACH configuration may also be used by a legacy UE (e.g., a UE that cannot perform dynamic adaptation). A second RACH configuration, together with the first RACH configuration, may be used by a UE that can perform dynamic adaptation (e.g., the UE 602). The first RACH configuration 612 may include one or more parameters or values of IEs that may be different from the second PRACH configuration 614. For the UE that can perform dynamic adaptation, in some aspects, the UE may follow the second RACH configuration 614 for a period of time (e.g., 626) (that may be configured by the network or configured without signaling) to communicate with the network (e.g., at 620) and switch back to the first RACH configuration 612 (which may also be used by the UEs that cannot perform dynamic adaptation). For the UE that can perform dynamic adaptation, in some aspects, the UE may switch (e.g., at 624) between the first RACH configuration 612 and the second RACH configuration 614 based on a dynamic switch indication 622 from the network (e.g., the network entity 604). The UE 602 may communicate (e.g., at 628) with the network after switching back to the first configuration 612. For the UE that can perform dynamic adaptation, in some aspects, the UE (e.g., the UE 602) may follow a RACH configuration based on the union of the two RACH configuration indices. The UE may also map SSB to configured ROs at 618.

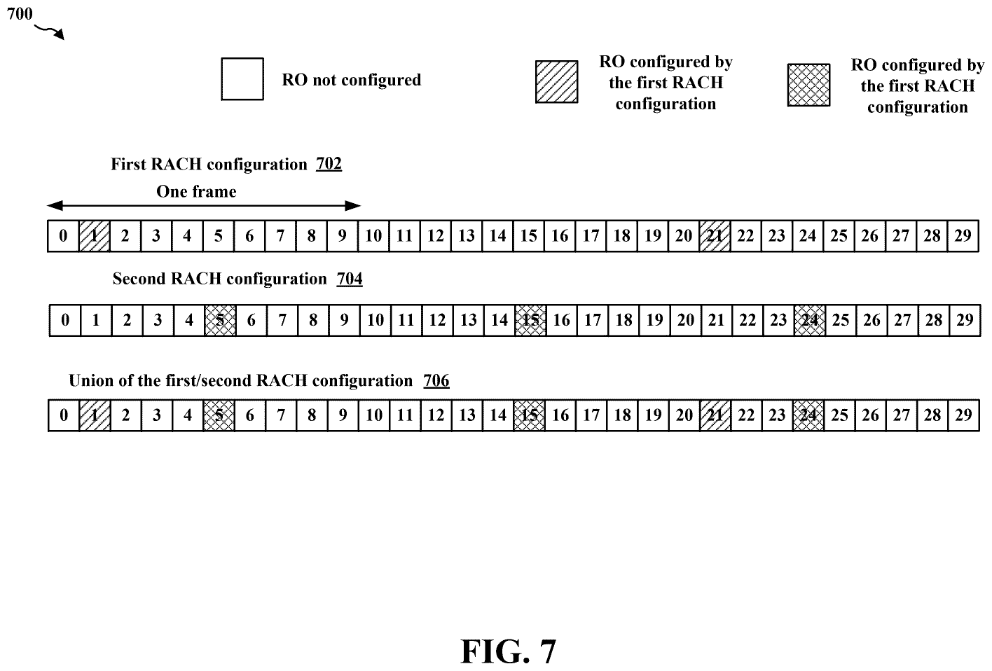

FIG. 7 is a diagram 700 illustrating an example of RACH adaptation with a first RACH configuration 702 and a second RACH configuration 704. As illustrated in FIG. 7, a RO index may include 30 total ROs where 10 ROs occupy one frame. The 30 ROs may be indexed based on 0 to 29. For the first RACH configuration 702, RO 1 and RO 21 may be configured. For the second RACH configuration 704, RO 5, RO 15, and RO 24 may be configured. In some aspects, a union of the two RACH configurations may be all the PRACH resources that belong to the RACH configurations. In some aspects, the union of the two RACH configurations may be included in a “combined RACH configuration” or “combined PRACH configuration.” In some aspects, the union may be the combined RACH configuration. For example, the union 706 of the first RACH configuration 702 and the second RACH configuration 704 may include RO 1, RO 5, RO 15, RO 21, and RO 24.

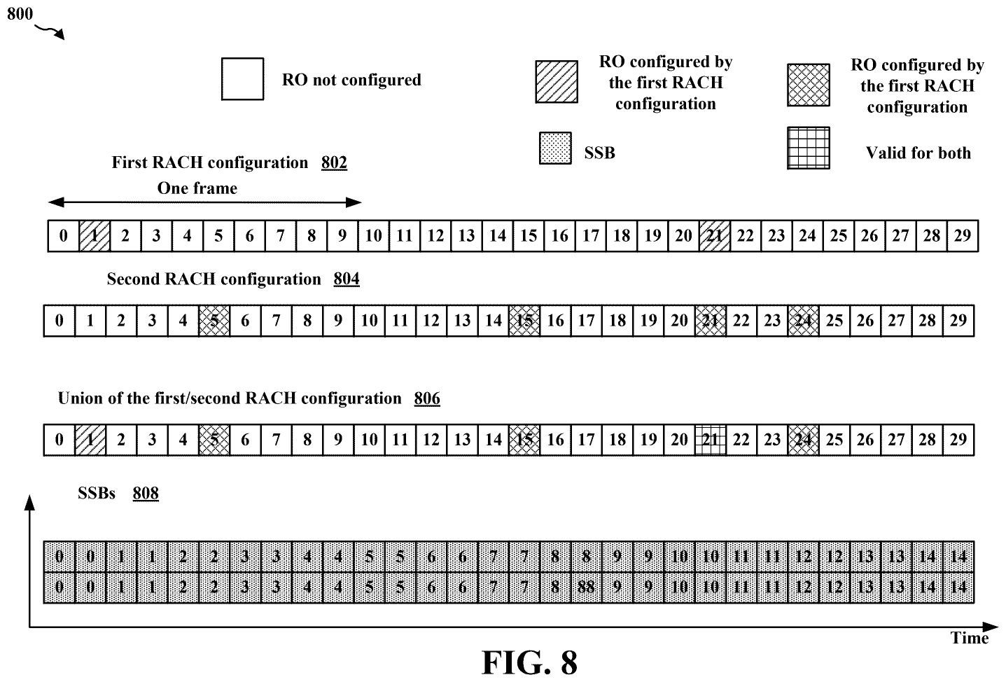

FIG. 8 is a diagram 800 illustrating an example of synchronization signal block (SSB) mapping with a first RACH configuration and a second RACH configuration. As illustrated in FIG. 8, a RO index may include 30 total ROs where 10 ROs occupy one frame. The 30 ROs may be indexed based on 0 to 29. For the first RACH configuration 802, RO 1 and RO 21 may be configured. For the second RACH configuration 804, RO 5, RO 15, RO 21, and RO 24 may be configured. In some aspects, a union of the two RACH configurations may be all the PRACH resources that belong to the RACH configurations. For example, the union 806 of the first RACH configuration 802 and the second RACH configuration 804 may include RO 1, RO 5, RO 15, RO 21, and RO 24. In some aspects, the UE may perform SSB to RO mapping of the union of two RACH configurations based on mapping the SSB to ROs separately for each configuration. In some aspects, the UE may perform SSB to RO mapping of the union of two RACH configurations based on mapping the SSB to ROs to the union of the configurations. For example, in some aspects, the UE may map SSBs 808 to ROs of the first RACH configuration 802 and ROs of the second RACH configuration 804 separately. In some aspects, the UE may map SSBs 808 to the union 806.

In some aspects where the UE map SSBs 808 to ROs of the first RACH configuration 802 and ROs of the second RACH configuration 804 separately, an RO may be overlapping between the first RACH configuration 802 and the second RACH configuration 804. For example, the RO 21 may be configured for both the first RACH configuration 802 and the second RACH configuration 804 and the RO 21 may be considered to be valid for the first RACH configuration 802, the second RACH configuration 804, and the union 806.

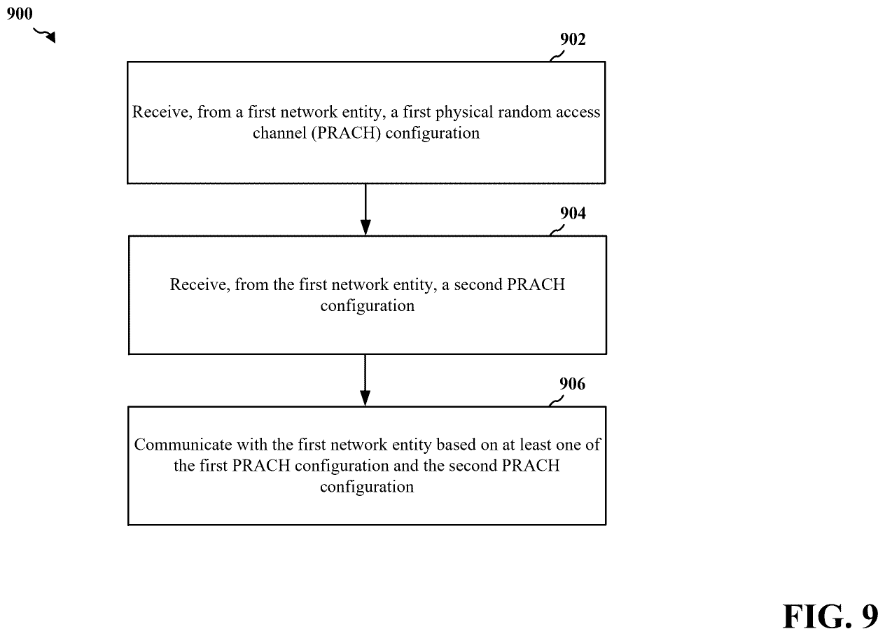

FIG. 9 is a flowchart 900 of a method of wireless communication. The method may be performed by a UE (e.g., the UE 104, the UE 602; the apparatus 1104).

At 902, the UE may receive, from a first network entity, a first physical random access channel (PRACH) configuration. For example, the UE 602 may receive, from a first network entity 604, a first physical random access channel (PRACH) configuration (e.g., 612). In some aspects, 902 may be performed by RACH component 198.

At 904, the UE may receive, from the first network entity, a second PRACH configuration. For example, the UE 602 may receive, from the first network entity 604, a second PRACH configuration (e.g., 614). In some aspects, 904 may be performed by RACH component 198.

At 906, the UE may communicate with the first network entity based on at least one of the first PRACH configuration and the second PRACH configuration. For example, the UE 602 may communicate with the first network entity 604 based on at least one of the first PRACH configuration 612 and the second PRACH configuration 614. In some aspects, 906 may be performed by RACH component 198.

In some aspects, to communicate with the first network entity 604 based on at least one of the first PRACH configuration (e.g., 612) and the second PRACH configuration (e.g., 614), the UE 602 may communicate with the first network entity 604 based on the first PRACH configuration (e.g., 612) and not the second PRACH configuration (e.g., 614) based on a lack of reception of a dynamic indication (e.g., 622). In some aspects, to communicate with the first network entity 604 based on at least one of the first PRACH configuration (e.g., 612) and the second PRACH configuration (e.g., 614), the UE 602 may communicate with the first network entity 604 based on the second PRACH configuration (e.g., 614) for a period of time (e.g., 626) and communicate with the first network entity 604 based on the first PRACH configuration (e.g., 612) after the period of time (e.g., 626).

In some aspects, to communicate with the first network entity 604 based on at least one of the first PRACH configuration (e.g., 612) and the second PRACH configuration (e.g., 614), the UE 602 may receive, from the first network entity 604, a dynamic indication (e.g., 622) that indicates a usage of the second PRACH configuration (e.g., 614) and communicate with the first network entity 604 based on the second PRACH configuration (e.g., 614) and not the first PRACH configuration (e.g., 612) based on reception of the dynamic indication (e.g., 622).

In some aspects, to communicate with the first network entity 604 based on at least one of the first PRACH configuration (e.g., 612) and the second PRACH configuration (e.g., 614), the UE 602 may communicate with the first network entity 604 based on a combined PRACH configuration including a union of the first PRACH configuration (e.g., 612) and the second PRACH configuration (e.g., 614), where the combined PRACH configuration includes a first set of PRACH resources in the first PRACH configuration (e.g., 612) and a second set of PRACH resources in the second PRACH configuration (e.g., 614). In some aspects, the first set of PRACH resources is associated with a first PRACH configuration index (e.g., index of 0-29 illustrated in FIG. 7 or FIG. 8) and the second set of PRACH resources is associated with a second PRACH configuration index (e.g., index of 0-29 illustrated in FIG. 7 or FIG. 8), such that the combined PRACH configuration is associated with the first PRACH configuration index and the second PRACH configuration index.

In some aspects, to communicate with the first network entity 604 based on at least one of the first PRACH configuration (e.g., 612) and the second PRACH configuration (e.g., 614), the UE 602 may map a set of synchronization signal blocks (SSBs) (e.g., 808) to a set of random access occasions (ROs) separately for the first PRACH configuration (e.g., 802/612) and the second PRACH configuration (e.g., 804/614).

In some aspects, to communicate with the first network entity 604 based on at least one of the first PRACH configuration (e.g., 612) and the second PRACH configuration (e.g., 614), the UE 602 may map a set of SSBs (e.g., 808) to a set of random access occasions (ROs) to the combined PRACH configuration (e.g., including the union 806) of the first PRACH configuration (e.g., 612) and the second PRACH configuration (e.g., 614).

In some aspects, at least random access occasion (e.g., RO 21 in FIG. 8) is valid for the first PRACH configuration (e.g., 612) and the second PRACH configuration (e.g., 614) and a combined PRACH configuration including a union (e.g., 806) of the first PRACH configuration (e.g., 612) and the second PRACH configuration (e.g., 614).

In some aspects, to communicate with the first network entity 604 based on at least one of the first PRACH configuration (e.g., 612) and the second PRACH configuration (e.g., 614), the UE 602 may map a set of SSBs (e.g., 808) to a set of random access occasions (ROs) separately for the first PRACH configuration (e.g., 612) and the second PRACH configuration (e.g., 614).

In some aspects, to communicate with the first network entity 604 based on at least one of the first PRACH configuration (e.g., 612) and the second PRACH configuration (e.g., 614), the UE 602 may transmit a preamble based on the first PRACH configuration (e.g., 612) or the second PRACH configuration (e.g., 614).

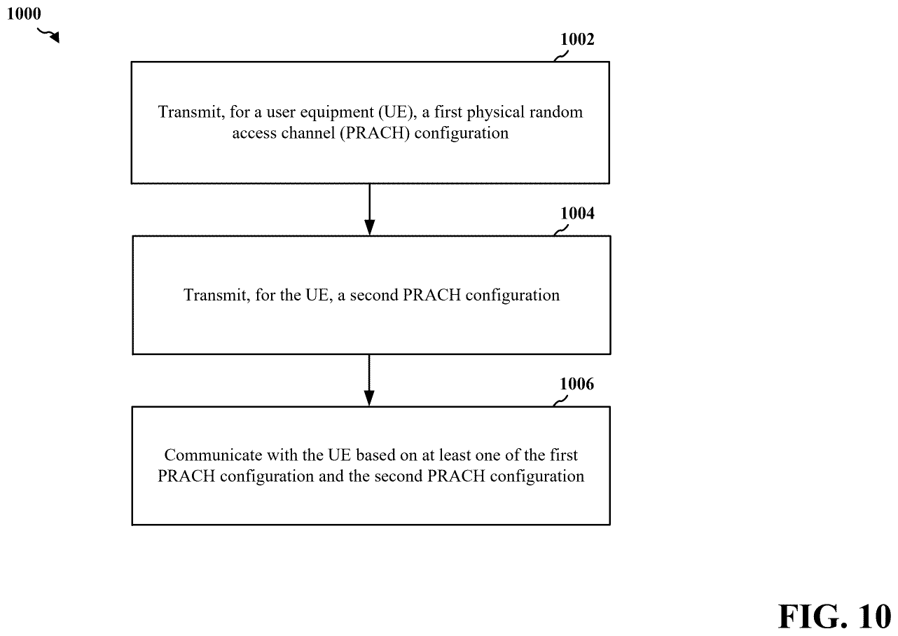

FIG. 10 is a flowchart 1000 of a method of wireless communication. The method may be performed by a network entity (e.g., the base station 102, the network entity 604; the apparatus 1104, the network entity 1202).

At 1002, the network entity may transmit, for a UE, a first physical random access channel (PRACH) configuration. For example, the network entity 604 may transmit, for a UE 602, a first physical random access channel (PRACH) configuration (e.g., 612). In some aspects, 1002 may be performed by RACH component 199.

At 1004, the network entity may transmit, for the UE, a second PRACH configuration. For example, the network entity 604 may transmit, for the UE 602, a second PRACH configuration (e.g., 614). In some aspects, 1004 may be performed by RACH component 199.

At 1006, the network entity may communicate with the UE based on at least one of the first PRACH configuration and the second PRACH configuration. For example, the network entity 604 may communicate with the UE 602 based on at least one of the first PRACH configuration 612 and the second PRACH configuration 614. In some aspects, 1006 may be performed by RACH component 199.

In some aspects, to communicate with the UE 602 based on at least one of the first PRACH configuration (e.g., 612) and the second PRACH configuration (e.g., 614), the network entity 604 may communicate with the UE 602 based on the first PRACH configuration (e.g., 612) and not the second PRACH configuration (e.g., 614) based on a lack of transmission of a dynamic indication (e.g., 622). In some aspects, to communicate with the UE 602 based on at least one of the first PRACH configuration (e.g., 612) and the second PRACH configuration (e.g., 614), the network entity 604 may communicate with the UE 602 based on the second PRACH configuration (e.g., 614) for a period of time (e.g., 626) and communicate with the UE 602 based on the first PRACH configuration (e.g., 612) after the period of time (e.g., 626).

In some aspects, to communicate with the UE 602 based on at least one of the first PRACH configuration (e.g., 612) and the second PRACH configuration (e.g., 614), the network entity 604 may transmit, for the UE 602, a dynamic indication (e.g., 622) that indicates a usage of the second PRACH configuration (e.g., 614) and communicate with the UE 602 based on the second PRACH configuration (e.g., 614) and not the first PRACH configuration (e.g., 612) based on transmission of the dynamic indication (e.g., 622).

In some aspects, to communicate with the UE 602 based on at least one of the first PRACH configuration (e.g., 612) and the second PRACH configuration (e.g., 614), the network entity 604 may communicate with the UE 602 based on a combined PRACH configuration including a union of the first PRACH configuration (e.g., 612) and the second PRACH configuration (e.g., 614), where the combined PRACH configuration includes a first set of PRACH resources in the first PRACH configuration (e.g., 612) and a second set of PRACH resources in the second PRACH configuration (e.g., 614). In some aspects, the first set of PRACH resources is associated with a first PRACH configuration index (e.g., index of 0-29 illustrated in FIG. 7 or FIG. 8) and the second set of PRACH resources is associated with a second PRACH configuration index (e.g., index of 0-29 illustrated in FIG. 7 or FIG. 8), such that the combined PRACH configuration is associated with the first PRACH configuration index and the second PRACH configuration index. In some aspects, the network entity may receive a preamble based on the first PRACH configuration or the second PRACH configuration.

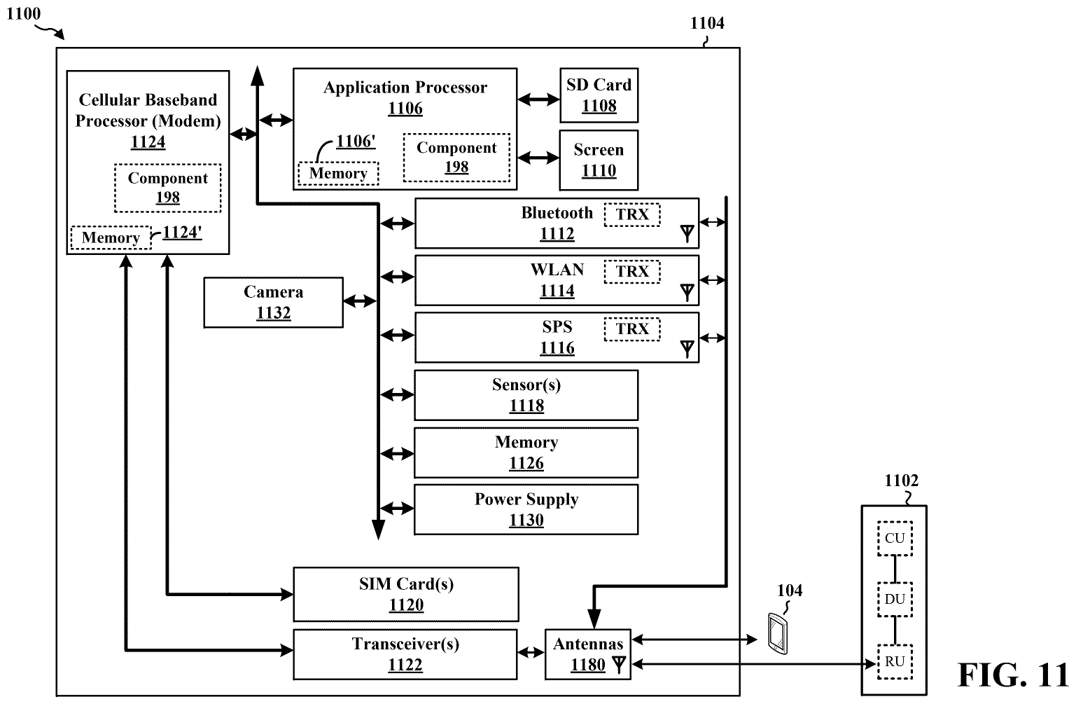

FIG. 11 is a diagram 1100 illustrating an example of a hardware implementation for an apparatus 1104. The apparatus 1104 may be a UE, a component of a UE, or may implement UE functionality. In some aspects, the apparatus 1004 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the RACH component 198 may be configured to receive, from a first network entity, a first physical random access channel (PRACH) configuration. In some aspects, the RACH component 198 may be further configured to receive, from the first network entity, a second PRACH configuration. In some aspects, the RACH component 198 may be further configured to communicate with the first network entity based on at least one of the first PRACH configuration and the second PRACH configuration. The RACH component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for receiving, from a first network entity, a first physical random access channel (PRACH) configuration. In some aspects, the apparatus 1104 may include means for receiving, from the first network entity, a second PRACH configuration. In some aspects, the apparatus 1104 may include means for communicating with the first network entity based on at least one of the first PRACH configuration and the second PRACH configuration. In some aspects, the apparatus 1104 may include means for communicating with the first network entity based on the first PRACH configuration and not the second PRACH configuration based on a lack of reception of a dynamic indication. In some aspects, the apparatus 1104 may include means for communicating with the first network entity based on the second PRACH configuration for a period of time. In some aspects, the apparatus 1104 may include means for communicating with the first network entity based on the first PRACH configuration after the period of time. In some aspects, the apparatus 1104 may include means for receiving, from the first network entity, a dynamic indication that indicates a usage of the second PRACH configuration. In some aspects, the apparatus 1104 may include means for communicating with the first network entity based on the second PRACH configuration and not the first PRACH configuration based on reception of the dynamic indication. In some aspects, the apparatus 1104 may include means for communicating with the first network entity based on a union of the first PRACH configuration and the second PRACH configuration, where the union comprises a first set of PRACH resources associated with the first PRACH configuration and a second set of PRACH resources associated with the second PRACH configuration. In some aspects, the apparatus 1104 may include means for mapping a set of synchronization signal blocks (SSBs) to a set of random access occasions (ROs) separately for the first PRACH configuration and the second PRACH configuration. In some aspects, the apparatus 1104 may include means for mapping a set of synchronization signal blocks (SSBs) to a set of random access occasions (ROs) to the union of the first PRACH configuration and the second PRACH configuration. In some aspects, the apparatus 1104 may include means for mapping a set of synchronization signal blocks (SSBs) to a set of random access occasions (ROs) separately for the first PRACH configuration and the second PRACH configuration. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

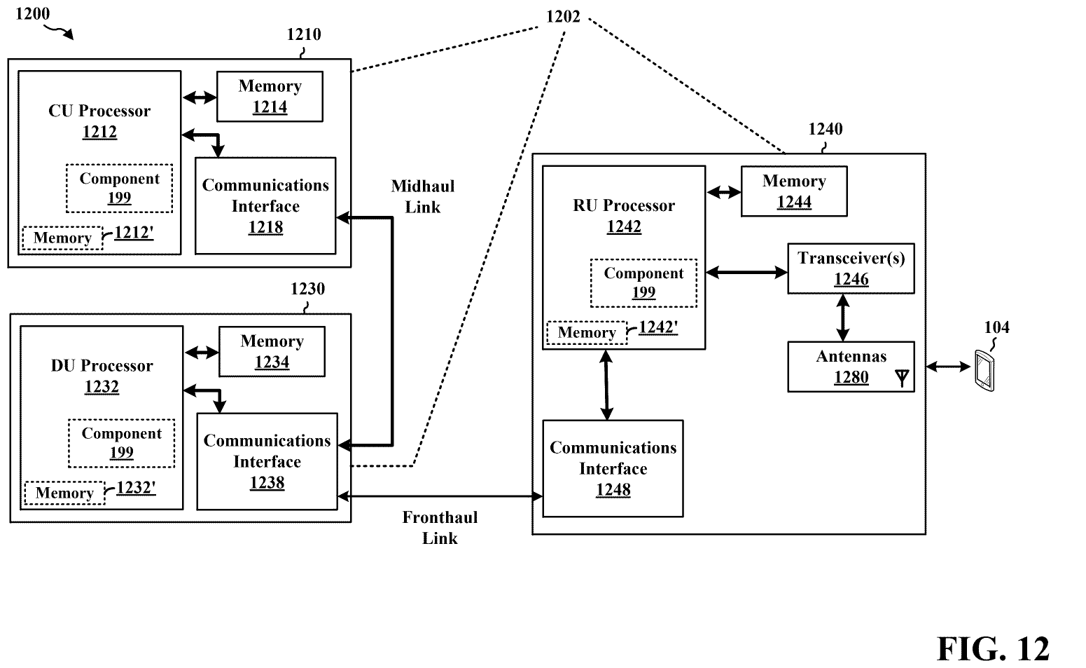

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the RACH component 199 may be configured to transmit, for a UE, a first PRACH configuration. In some aspects, the RACH component 199 may be further configured to transmit, for the UE, a second PRACH configuration. In some aspects, the RACH component 199 may be further configured to communicate with the UE based on at least one of the first PRACH configuration and the second PRACH configuration. The RACH component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for transmitting, for a user equipment (UE), a first physical random access channel (PRACH) configuration. In some aspects, the network entity 1202 may include means for transmitting, for the UE, a second PRACH configuration. In some aspects, the network entity 1202 may include means for communicating with the UE based on at least one of the first PRACH configuration and the second PRACH configuration. In some aspects, the network entity 1202 may include means for communicating with the UE based on the first PRACH configuration and not the second PRACH configuration based on a lack of transmission of a dynamic indication. In some aspects, the network entity 1202 may include means for communicating with the UE based on the second PRACH configuration for a period of time. In some aspects, the network entity 1202 may include means for communicating with the UE based on the first PRACH configuration after the period of time. In some aspects, the network entity 1202 may include means for transmitting, to the UE, an indication of the period of time. In some aspects, the network entity 1202 may include means for transmitting, for the UE, a dynamic indication that indicates a usage of the second PRACH configuration. In some aspects, the network entity 1202 may include means for communicating with the UE based on the second PRACH configuration and not the first PRACH configuration based on transmission of the dynamic indication. In some aspects, the network entity 1202 may include means for communicate with the UE based on a combined PRACH configuration including a union of the first PRACH configuration and the second PRACH configuration, where the combined PRACH configuration includes a first set of PRACH resources in the first PRACH configuration and a second set of PRACH resources in the second PRACH configuration. In some aspects, the network entity 1202 may include means for receiving a preamble based on the first PRACH configuration or the second PRACH configuration. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication performed by a user equipment (UE), including: receiving, from a first network entity, a first physical random access channel (PRACH) configuration; receiving, from the first network entity, a second PRACH configuration; and communicating with the first network entity based on at least one of the first PRACH configuration and the second PRACH configuration.

Aspect 2 is the method of aspect 1, where communicating with the first network entity based on at least one of the first PRACH configuration and the second PRACH configuration includes: communicating with the first network entity based on the first PRACH configuration and not the second PRACH configuration based on a lack of reception of a dynamic indication.

Aspect 3 is the method of any of aspects 1-2, where communicating with the first network entity based on at least one of the first PRACH configuration and the second PRACH configuration includes: communicating with the first network entity based on the second PRACH configuration for a period of time; and communicating with the first network entity based on the first PRACH configuration after the period of time.

Aspect 4 is the method of any of aspects 1-3, where communicating with the first network entity based on at least one of the first PRACH configuration and the second PRACH configuration includes: receiving, from the first network entity, a dynamic indication that indicates a usage of the second PRACH configuration; and communicating with the first network entity based on the second PRACH configuration and not the first PRACH configuration based on reception of the dynamic indication.

Aspect 5 is the method of any of aspects 1-4, where communicating with the first network entity based on at least one of the first PRACH configuration and the second PRACH configuration includes: communicating with the first network entity based on a combined PRACH configuration including a union of the first PRACH configuration and the second PRACH configuration, where the combined PRACH configuration includes a first set of PRACH resources in the first PRACH configuration and a second set of PRACH resources in the second PRACH configuration.

Aspect 6 is the method of any of aspects 5, where the first set of PRACH resources is associated with a first PRACH configuration index and the second set of PRACH resources is associated with a second PRACH configuration index, such that the combined PRACH configuration is associated with the first PRACH configuration index and the second PRACH configuration index.

Aspect 7 is the method of aspect 5, where communicating with the first network entity based on at least one of the first PRACH configuration and the second PRACH configuration includes: mapping a set of synchronization signal blocks (SSBs) to a set of random access occasions (ROs) separately for the first PRACH configuration and the second PRACH configuration.

Aspect 8 is the method of aspect 5, where communicating with the first network entity based on at least one of the first PRACH configuration and the second PRACH configuration includes: mapping a set of synchronization signal blocks (SSBs) to a set of random access occasions (ROs) to the combined PRACH configuration.

Aspect 9 is the method of any of aspects 1-8, where at least random access occasion is valid for the first PRACH configuration and the second PRACH configuration and a combined PRACH configuration including a union of the first PRACH configuration and the second PRACH configuration.

Aspect 10 is the method of aspect 9, where communicating with the first network entity based on at least one of the first PRACH configuration and the second PRACH configuration includes: mapping a set of synchronization signal blocks (SSBs) to a set of random access occasions (ROs) separately for the first PRACH configuration and the second PRACH configuration.

Aspect 11 is the method of any of aspects 1-10, where communicating with the first network entity based on at least one of the first PRACH configuration and the second PRACH configuration includes: transmitting a preamble based on the first PRACH configuration or the second PRACH configuration.

Aspect 12 is a method for wireless communication performed by a network node, including: transmitting, for a user equipment (UE), a first physical random access channel (PRACH) configuration; transmitting, for the UE, a second PRACH configuration; and communicating with the UE based on at least one of the first PRACH configuration and the second PRACH configuration.

Aspect 13 is the method of aspect 12, where communicating with the UE based on at least one of the first PRACH configuration and the second PRACH configuration further includes: communicating with the UE based on the first PRACH configuration and not the second PRACH configuration based on a lack of transmission of a dynamic indication.

Aspect 14 is the method of any of aspects 12-13, where communicating with the UE based on at least one of the first PRACH configuration and the second PRACH configuration further includes: communicating with the UE based on the second PRACH configuration for a period of time; and communicating with the UE based on the first PRACH configuration after the period of time.

Aspect 15 is the method of aspect 14, further including: transmitting, to the UE, an indication of the period of time.

Aspect 16 is the method of any of aspects 12-15, where communicating with the UE based on at least one of the first PRACH configuration and the second PRACH configuration further includes: transmitting, for the UE, a dynamic indication that indicates a usage of the second PRACH configuration; and communicating with the UE based on the second PRACH configuration and not the first PRACH configuration based on transmission of the dynamic indication.

Aspect 17 is the method of any of aspects 12-16, where communicating with the UE based on at least one of the first PRACH configuration and the second PRACH configuration further includes: communicating with the UE based on a combined PRACH configuration including a union of the first PRACH configuration and the second PRACH configuration, where the combined PRACH configuration includes a first set of PRACH resources in the first PRACH configuration and a second set of PRACH resources in the second PRACH configuration.

Aspect 18 is the method of aspect 17, where the first set of PRACH resources is associated with a first PRACH configuration index and the second set of PRACH resources is associated with a second PRACH configuration index, such that the combined PRACH configuration is associated with the first PRACH configuration index and the second PRACH configuration index.

Aspect 19 is the method of any of aspects 12-18, where communicating with the UE based on at least one of the first PRACH configuration and the second PRACH configuration further includes: receiving a preamble based on the first PRACH configuration or the second PRACH configuration.

Aspect 20 is an apparatus for wireless communication at a wireless device including at least one memory and at least one processor coupled to the at least one memory and, based at least in part on information stored in the at least one memory, the at least one processor is configured, individually or in combination, to implement any of aspects 1 to 11.

Aspect 21 is the apparatus of aspect 20, further including one or more transceivers or one or more antennas coupled to the at least one processor.

Aspect 22 is an apparatus for wireless communication at a wireless device including means for implementing any of aspects 1 to 11.

Aspect 23 is a computer-readable medium (e.g., a non-transitory computer-readable medium) storing computer executable code, where the code when executed by at least one processor causes the at least one processor to implement any of aspects 1 to 11.

Aspect 24 is an apparatus for wireless communication at a wireless device including at least one memory and at least one processor coupled to the at least one memory and, based at least in part on information stored in the at least one memory, the at least one processor is configured, individually or in combination, to implement any of aspects 12 to 19.

Aspect 25 is the apparatus of aspect 24, further including one or more transceivers or one or more antennas coupled to the at least one processor.

Aspect 26 is an apparatus for wireless communication at a wireless device including means for implementing any of aspects 12 to 19.

Aspect 27 is a computer-readable medium (e.g., a non-transitory computer-readable medium) storing computer executable code, where the code when executed by at least one processor causes the at least one processor to implement any of aspects 12 to 19.

What is claimed is:

1. An apparatus for wireless communication at a user equipment (UE), comprising:
at least one memory; and
at least one processor coupled to the at least one memory, and based at least in part on information stored in the at least one memory, the at least one processor, individually or in any combination, is configured to cause the UE to:
receive, from a first network entity, a first physical random access channel (PRACH) configuration;
receive, from the first network entity, a second PRACH configuration; and
communicate with the first network entity based on at least one of the first PRACH configuration and the second PRACH configuration.

2. The apparatus of claim 1, wherein to communicate with the first network entity based on at least one of the first PRACH configuration and the second PRACH configuration, the at least one processor, individually or in any combination, is configured to cause the UE to:
communicate with the first network entity based on the first PRACH configuration and not the second PRACH configuration based on a lack of reception of a dynamic indication.

3. The apparatus of claim 1, wherein to communicate with the first network entity based on at least one of the first PRACH configuration and the second PRACH configuration, the at least one processor, individually or in any combination, is configured to cause the UE to:
communicate with the first network entity based on the second PRACH configuration for a period of time; and
communicate with the first network entity based on the first PRACH configuration after the period of time.

4. The apparatus of claim 1, wherein to communicate with the first network entity based on at least one of the first PRACH configuration and the second PRACH configuration, the at least one processor, individually or in any combination, is configured to cause the UE to:
receive, from the first network entity, a dynamic indication that indicates a usage of the second PRACH configuration; and
communicate with the first network entity based on the second PRACH configuration and not the first PRACH configuration based on reception of the dynamic indication.

5. The apparatus of claim 1, wherein to communicate with the first network entity based on at least one of the first PRACH configuration and the second PRACH configuration, the at least one processor, individually or in any combination, is configured to cause the UE to:
communicate with the first network entity based on a combined PRACH configuration including a union of the first PRACH configuration and the second PRACH configuration, wherein the combined PRACH configuration comprises a first set of PRACH resources in the first PRACH configuration and a second set of PRACH resources in the second PRACH configuration.

6. The apparatus of claim 5, wherein the first set of PRACH resources is associated with a first PRACH configuration index and the second set of PRACH resources is associated with a second PRACH configuration index, such that the combined PRACH configuration is associated with the first PRACH configuration index and the second PRACH configuration index.

7. The apparatus of claim 5, wherein to communicate with the first network entity based on at least one of the first PRACH configuration and the second PRACH configuration, the at least one processor, individually or in any combination, is configured to cause the UE to:
map a set of synchronization signal blocks (SSBs) to a set of random access occasions (ROs) separately for the first PRACH configuration and the second PRACH configuration.

8. The apparatus of claim 5, wherein to communicate with the first network entity based on at least one of the first PRACH configuration and the second PRACH configuration, the at least one processor, individually or in any combination, is configured to cause the UE to:
map a set of synchronization signal blocks (SSBs) to a set of random access occasions (ROs) to the combined PRACH configuration.

9. The apparatus of claim 1, wherein at least random access occasion is valid for the first PRACH configuration and the second PRACH configuration and a combined PRACH configuration including a union of the first PRACH configuration and the second PRACH configuration.

10. The apparatus of claim 9, wherein to communicate with the first network entity based on at least one of the first PRACH configuration and the second PRACH configuration, the at least one processor, individually or in any combination, is configured to cause the UE to:
map a set of synchronization signal blocks (SSBs) to a set of random access occasions (ROs) separately for the first PRACH configuration and the second PRACH configuration.

11. The apparatus of claim 1, further comprising at least one transceiver coupled with the at least one processor, and wherein to communicate with the first network entity based on at least one of the first PRACH configuration and the second PRACH configuration, the at least one processor, individually or in any combination, is configured to cause the UE to:
transmit a preamble based on the first PRACH configuration or the second PRACH configuration.

12. A method for wireless communication performed by a user equipment (UE), comprising:
receiving, from a first network entity, a first physical random access channel (PRACH) configuration;
receiving, from the first network entity, a second PRACH configuration; and
communicating with the first network entity based on at least one of the first PRACH configuration and the second PRACH configuration.

13. An apparatus for wireless communication at a network node, comprising:
at least one memory; and
at least one processor coupled to the at least one memory, and based at least in part on information stored in the at least one memory, the at least one processor, individually or in any combination, is configured to cause the network node to:
transmit, for a user equipment (UE), a first physical random access channel (PRACH) configuration;
transmit, for the UE, a second PRACH configuration; and
communicate with the UE based on at least one of the first PRACH configuration and the second PRACH configuration.

14. The apparatus of claim 13, wherein to communicate with the UE based on at least one of the first PRACH configuration and the second PRACH configuration, the at least one processor, individually or in any combination, is configured to cause the network node to:
communicate with the UE based on the first PRACH configuration and not the second PRACH configuration based on a lack of transmission of a dynamic indication.

15. The apparatus of claim 13, wherein to communicate with the UE based on at least one of the first PRACH configuration and the second PRACH configuration, the at least one processor, individually or in any combination, is configured to cause the network node to:
communicate with the UE based on the second PRACH configuration for a period of time; and
communicate with the UE based on the first PRACH configuration after the period of time.

16. The apparatus of claim 15, wherein the least one processor, individually or in any combination, is further configured to cause the network node to:
transmit, to the UE, an indication of the period of time.

17. The apparatus of claim 13, wherein to communicate with the UE based on at least one of the first PRACH configuration and the second PRACH configuration, the at least one processor, individually or in any combination, is configured to cause the network node to:
transmit, for the UE, a dynamic indication that indicates a usage of the second PRACH configuration; and
communicate with the UE based on the second PRACH configuration and not the first PRACH configuration based on transmission of the dynamic indication.

18. The apparatus of claim 13, wherein to communicate with the UE based on at least one of the first PRACH configuration and the second PRACH configuration, the at least one processor, individually or in any combination, is configured to cause the network node to:
communicate with the UE based on a combined PRACH configuration including a union of the first PRACH configuration and the second PRACH configuration, wherein the combined PRACH configuration comprises a first set of PRACH resources in the first PRACH configuration and a second set of PRACH resources in the second PRACH configuration.

19. The apparatus of claim 18, wherein the first set of PRACH resources is associated with a first PRACH configuration index and the second set of PRACH resources is associated with a second PRACH configuration index, such that the combined PRACH configuration is associated with the first PRACH configuration index and the second PRACH configuration index.

20. The apparatus of claim 13, further comprising at least one transceiver coupled with the at least one processor, and wherein to communicate with the UE based on at least one of the first PRACH configuration and the second PRACH configuration, the at least one processor, individually or in any combination, is configured to cause the network node to:
receive a preamble based on the first PRACH configuration or the second PRACH configuration.
